(19) United States
(12) Patent Application Publication
(10) Pub. No.: US 2006/0198921 A1
(43) Pub. Date: Sep. 7, 2006

(54) Structure for preventing resin leak

(76) Inventor: Naohiro Fujita, Fuji-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/350,166

(22) Filed: Feb. 8, 2006

(30) Foreign Application Priority Data
Feb. 9, 2005 (JP) P2005-032514

(51) Int. Cl. B29C 45/00

(52) U.S. Cl. 425/542

(57) ABSTRACT

Disclosed is a structure for preventing resin leak of an injection molding of a resin covering layer on a covering surface of an insert member using a molding die which includes a first mold and a second mold which forms a cavity in combination with the first mold. The cavity receives the covering surface of the insert member for forming the resin covering layer. The first mold and the second mold include clamping surfaces which face each other and receive a portion of the insert member therebetween. The structure includes i) a first sealing portion provided on the portion of the insert member facing a location of the clamping surface near the cavity. The first sealing portion includes a ridge formed at the portion of the insert member.

### BACKGROUND OF THE INVENTION

1. Field of the Invention

The present invention relates to a structure for preventing resin leak for an insert molding die. More particularly, the present invention relates to the structure for preventing resin leak of a molding die for forming a resin covering layer on a surface of an insert member.

2. Description of the Related Art

There is a conventional structure for preventing resin leak of a molding die disclosed in Japanese Patent Application Laid-Open No. 2001-217271. In this structure, a circuit board 7 on which a semiconductor chip is mounted is placed and fixed into a pit 8 in a lower mold 5, and then an upper mold 1 and the lower mold 5 are closed. Accordingly, sward-like projections 13 provided on the both sides of a runner of the upper mold 1 push down and shear the edges of the circuit board 7, and the projections themselves and the edges of the circuit board 7 that have been pushed down and plumped up closes a gap 9.

According to this structure, the gap 9 between the side surface of the circuit board 7 and the side surface of the pit 8 in the lower mold 5 can be closed, thus preventing resin from leaking into the gap 9.

However, with this proposed structure, it is not possible to stop the resin leaking out of a cavity. In particular, if a forming material with high fluidity is used, such resin material easily leaks out of the cavity, which causes flashes on a molded product.

Moreover, Japanese Patent Application Laid-Open No. Heisei 10(1998)-652 discloses an RIM (reaction injection molding) method for a steering wheel 70, and, in this method, a core bar 73 is inserted and covered with uncured polyurethane. Typically, in this type of RIM method for a steering wheel, a polyurethane thin flash extends from a spoke portion towards a boss side. A thin flash extending from a spoke portion of a steering wheel does not reach an attaching position of an air bag device. Therefore, this flash is not a problem in this case.

However, if another part is attached and fixed to the position with a thin flash, the thickness of the thin flash causes looseness of the part. In addition, if a screw or a clip is used in order to assemble a part to such a position, a thin flash causes problems like making it difficult to ensure pre-determined attachment strength

Further, even if a flash is thin, when a resin covering layer is thin, the flash slightly affects the consistency of the thickness of the resin covering layer of a product. For example, where a molded product is an air bag cover-united instrument panel, an unstable thickness of the resin covering layer may affect the stable air bag deploying performance.

### SUMMARY OF THE INVENTION

In the light of the above problems, an objective of the present invention is to provide a structure for preventing resin leak of a molding die, that prevents occurrence of flashes due to resin leakage for a molded product in which a resin covering layer is formed on an insert member, and that particularly prevents a flash at a position where a part is attached in the product so that an assembly operation is done easily, thus producing a formed product with a stable quality after assembly.

According to a first aspect of the present invention, there is provided a structure for preventing resin leak of an injection molding of a resin covering layer on a covering surface of an insert member using a molding die which includes a first mold and a second mold which forms a cavity in combination with the first mold, the cavity receiving the covering surface of the insert member for forming the resin covering layer, the first mold and the second mold including clamping surfaces which face each other and receive a portion of the insert member therebetween, the structure comprising: i) a first sealing portion provided on the portion of the insert member facing a location of the clamping surface near the cavity, the first sealing portion including: a ridge formed at the portion of the insert member.

According to a second aspect of the present invention, there is provided a structure for preventing resin leak of an injection molding of a resin covering layer on a covering surface of an insert member using a molding die which includes a first mold and a second mold which forms a cavity in combination with the fist mold, the cavity receiving the covering surface of the insert member for forming the resin covering layer, the first mold and the second mold including clamping surfaces which face each other and receive a portion of the insert member therebetween, the structure comprising: i) a first sealing portion provided on the portion of the insert member facing a location of the clamping surface near the cavity; and ii) a second sealing portion including: a) a ridge formed at a location within or near the first sealing portion, the ridge being formed at the portion of the insert member, and b) a groove formed at a location on the clamping surface which location corresponding to the ridge.

### BRIEF DESCRIPTION OF THE DRAWINGS

FIG. 1 is an explanatory view of a molding die that has a structure for preventing resin leak, according to a first embodiment of the present invention.

FIG. 2 is an explanatory view of a state where the molding die is closed and a second sealing portion is formed, before resin is injected into a cavity to form a resin covering layer on a surface of an insert member

FIG. 3 is an explanatory view of the whole molding die.

FIG. 4 is an explanatory view of the insert member and a lower mold used, according to the first embodiment.

FIG. 5 is an explanatory view of a molded product formed using the structure for preventing resin leak under the present invention.

FIG. 6 is an explanatory view of a structure for preventing resin leak, according to a second embodiment of the present invention.

FIG. 7 is an explanatory view of a structure for preventing resin leak, according to a third embodiment of the present invention.

### DETAILED DESCRIPTION OF THE EMBODIMENTS

For molding with the use of a structure for preventing resin leak of the present invention, materials to be used for an insert member and a resin covering layer on the surface of the insert member are not particularly limited. For example, for the insert member, materials such as thermosetting resin, thermoplastic resin and elastomer resin may be used. Moreover hard resins such as polypropylene resin and a combined material of polypropylene resin and a filler such as talc are preferred. A material for the resin covering layer on the surface of the insert member is not particularly limited either. Therefore, thermoplastic resin or two-component reactive resin may be used, and the resin used may be soft or hard. For example, polyurethane resin including foamed polyurethane and non-foamed polyurethane may be used.

As for a method for molding of a rein covering layer on an inert member by using a structure for preventing resin leak of the present invention, injection molding or reaction injection molding are particularly preferred. These molding methods are particularly preferred for molding of an air bag cover united with an instrument panel as these methods can give soft feelings to the instrument panel.

In the structure for preventing resin leak of the present invention, it is preferred that a ridge be united with the insert member when the insert member is formed. The shape of the ridge is not particularly limited as long as the ridge can comes into close contact with the corresponding mold surface during mold closure so that the ridge works as packing and creates a sealing portion. Further, according to another aspect of the present invention, it is preferred that, during mold closure the ridge be easily deformed and crushed within a groove made in the corresponding mold and have a volume that is received in the groove. Furthermore, the groove may have any shape as long as it can crush and receive the ridge during mold closure.

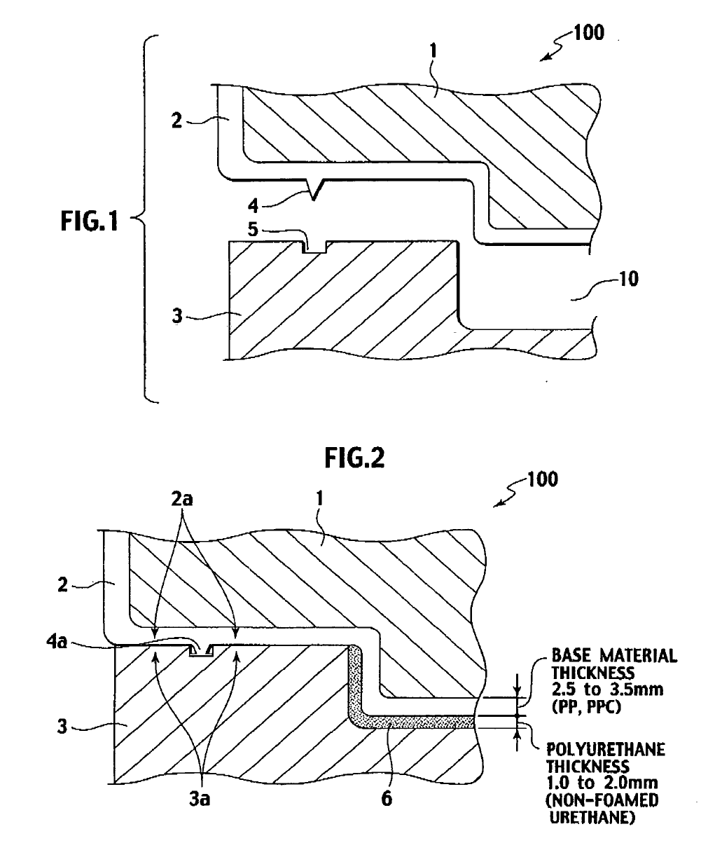

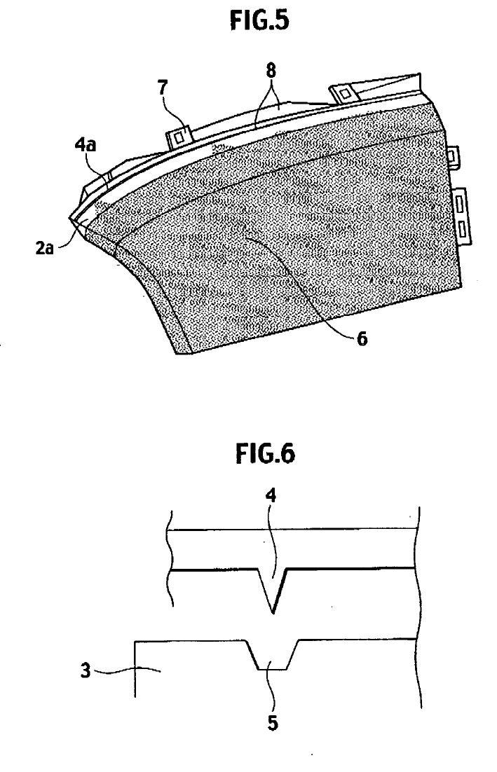

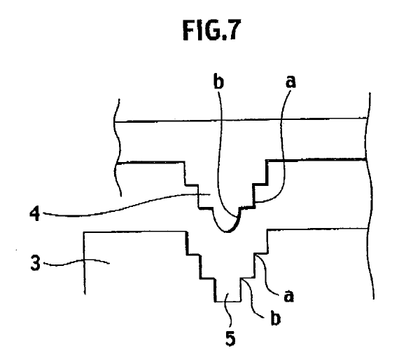

When i) a mold with the insert member placed thereon and ii) another mold are closed, the ridge produces a packing effect and forms the scaling portion, so a resin that is injected into a cavity to form a resin covering layer is prevented from leaking. Moreover, according to another aspect of the present invention (in FIG. 1, FIG. 6 and FIG. 7 to be described afterward), the ridge goes into the groove that is provided at the corresponding location and then is deformed and crushed in the groove. Therefore, the resin that is injected into the cavity to form the resin covering layer is prevented from leaking further from that location.

In the structure for preventing resin leak of the present invention, a sealing portion that includes the combination of the ridge and the groove is more preferred.

In this case, the insert member is sandwiched by two molds at a position next to the area of the insert member in which area the resin covering layer is formed in the cavity, and therefore, that position stops resin flow and serves as the seating portion. However, if the resin used for making the resin covering layer has high fluidity like a urethane forming material, this sealing portion cannot prevent resin leakage completely, and the resin leakage may proceed further to an outermost attachment piece. However, the structure for preventing resin leak of the present invention having the second sealing portion that includes the combination of the ridge and the groove can prevent resin leakage completely.

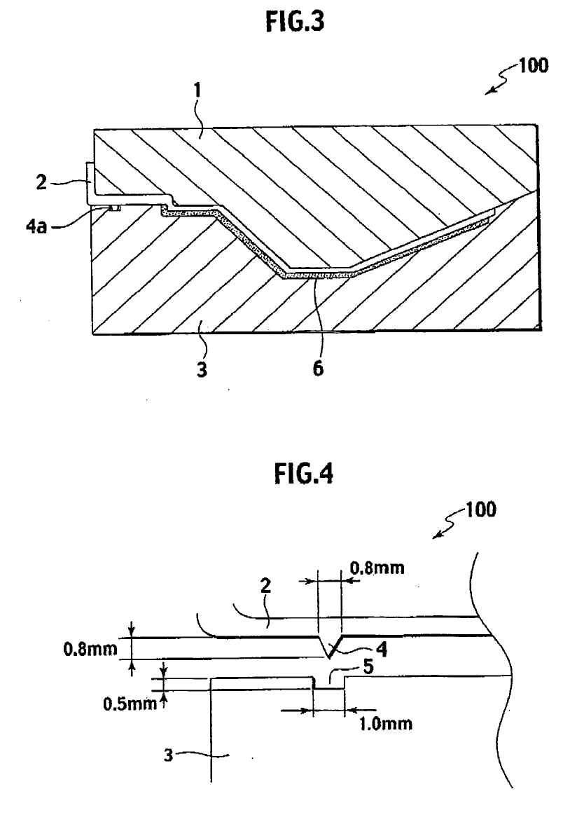

Herein below, the present invention is described in more detail with reference to the drawings. A structure for preventing resin leak 100 is shown in FIG. 1, FIG. 2, FIG. 3 and FIG. 4.

### First Embodiment

FIG. 1 explains a state where an inert member 2 is set on an upper mold 1. There is a ridge 4 provided in the insert member 2. Under the upper mold 1, there is a lower mold 3 in which a groove 5 that is shallower and wider than the ridge 4 is formed at a position corresponding to the ridge 4.

FIG. 2 is a view explaining a status where the upper mold 1 and the lower mold 3 shown in FIG. 1 are closed and resin for forming the resin covering layer 6 is injected into a cavity 10 so that the resin covering layer 6 is formed. At this time, the ridge 4 goes into the groove 5, and is crushed and received in the groove 5. But the crushed ridge 4 is so configured as not to be pushed out of the groove 5, and thus a second seal portion 4a is formed. FIG. 2 also shows a surface mating position 2a of the insert member 2 mating with a surface mating position 3a of the lower mold 3. At the surface mating position 2a and the surface mating position 3a, the insert member 2 is sandwiched between the upper mold 1 and the lower mold 3, forming a first sealing portion 2a, 3a, a combination of the surface mating position 2a and the surface mating position 3a. FIG. 3 is an explanatory view of the entire mold die of the structure for preventing resin leak 100

Molding of the air bag cover-united instrument panel is described as one of the most preferred examples of molding by using the structure for preventing resin leak 100 of the present invention.

In this case, it is preferred that the insert member 2 be made by injection molding using polypropylene resin or a combined material PPC of polypropylene resin and a filler (for example, talc).

Further, as shown in FIG. 2, the thickness of a base material of the insert member 2 is preferably between 2.5 mm to 3.5 mm. It is also preferred that the resin covering layer 6 that covers the surface of the insert member 2 is made by RIM using foamed polyurethane or non-foamed polyurethane as each gives soft feelings. A preferred thickness of the resin covering layer 6 is between 1.0 mm and 2.0 mm.

Moreover, as show in FIG. 4, as for the second sealing portion 4a, the ridge 4 provided in the insert member 2 has a triangle shape in cross section with its base width of 0.3 mm and height of 0.8 mm, and the groove 5 provided at the position corresponding to the ridge 4 has its width of 1.0 mm and the depth of 0.5 mm.

FIG. 5 is an explanatory view of a product formed by using the structure for preventing rosin leak 100 described above. There are some areas where the resin leaks from the first sealing portion 2a, 3a (2a and 3a on the right sides in FIG. 2) that are sandwiched between the upper mold 1 and the lower mold 3, and thin flashes can be observed. However, the resin is prevented from leaking beyond the second sealing portion 4a which is formed by i) the ridge 4 of the insert member 2 and ii) the groove 5 of the lower mold 3, preventing a flash from reaching an attachment piece 7 and an attachment part 8.

Therefore, what is needed is to inject a proper amount of polyurethane resin molding material required for forming the resin covering layer 6 of a molded product, which means one does not have to inject an extra amount of resin material for anticipated flashes as those shown in the conventional structure for preventing resin leak, and that prevents the polyurethane resin molding material from leaking to a PL surface that causes flashes. Accordingly, at any location of a molded product, the resin covering layer 6 with a constant desired thickness can be stably made for mass production. Hence, if the structure for preventing resin leak 100 is applied to the air bag cover, it reduces variation of air bag deployment performances.

Instead of forming the ridge 4 and the groove 5 as the second sealing portion 4a near the fist sealing portion 2a, 3a as described in the first embodiment above, it is possible to reduce the contact pressure between the insert member 2 and the groove 5 of the lower mold 3 on the outer side of the cavity 10 so that the insert member 2 at this contact position is not affected by compression power of mold closure.

Alternatively, it is also possible to make a pair of i) the first sealing portions 2a, 3a and ii) the second sealing portion 4a and provide a plurality of the above pairs in series. In this case, the second sealing portion 4a on the outer side and the other second sealing portion 4a on the inner side may have different or the same strength.

FIG. 6 and FIG. 7 are views of the second sealing portion 4a, according to a second embodiment and a third embodiment, respectively.

### Second Embodiment

FIG. 6 shows a case where the side walls of a groove 5 are tapered.

### Third Embodiment

FIG. 7 shows a case where the groove 5 and the ridge 4 each are so formed as to have a step shape in cross section. As shown in FIG. 7, when steps a and b are made in each of the groove 5 and the ridge 4, the structure will have a sealing function not only by deformation of the top end portion of the ridge 4 but also by the steps a and b of them contacting each other, producing sealing portions there as well. Therefore, the entire sealing performance is improved further. In this case, it is preferred to make this shape when the resin covering layer 6 is relatively thick as it is easier to form the shape of the ridge 4.

According to this invention, it becomes possible to prevent flashes from being made in an insert molded product beyond a predetermined point outside an area where a covering layer is made. Therefore, by setting an attachment part at a flash-free location, assembly operation of the molded product is carried out easily, and no flash removing work will be necessary, which improves productivity. Moreover, looseness or reduced strength that happen after assembly due to a remaining flash are prevented and a stable quality can be ensured. Furthermore, the quality of a molded product itself such as a uniform thickness of the covering layer of the molded product becomes stable. In particular, in the case of an air bag cover-united instrument panel, since varying thicknesses of a covering layer affects the air bag deployment performance, this structure for preventing resin leak can realize a stable quality and improved liability for such molded products.

The entire contents of Japanese Patent Application No. 2005-032514 (filed on Feb. 9, 2005 in Japan) from which priority is claimed are incorporated herein by reference, in order to take protection against mistranslation and omitted portions.

Although the present invention has been described above with reference to three embodiments, the present invention is, however, not limited to the above embodiments. Changes and modifications of the above embodiments may occur to those skilled in the art with reference to the above teachings.

The scope of the present invention is defined by the following claims.

What is claimed is:

1. A structure for preventing resin leak of an injection molding of a resin covering layer on a covering surface of an insert member using a molding die which includes a first mold and a second mold which forms a cavity in combination with the first mold, the cavity receiving the covering surface of the insert member for forming the resin covering layer, the first mold and the second mold including clamping surfaces which face each other and receive a portion of the insert member therebetween, the structure comprising:
i) a first sealing portion provided on the portion of the insert member facing a location of the clamping surface near the cavity, the first sealing portion including:
a ridge formed at the portion of the insert member.

2. The structure for preventing resin leak as claimed in claim 1, wherein the molding die is for a reaction injection molding.

3. The structure for preventing resin leak as claimed in claim 1, wherein the resin covering layer is made of polyurethane.

4. The structure for preventing resin leak as claimed in claim 1, wherein a thickness of the insert member is between 2.5 mm and 3.5 mm.

5. The structure for preventing resin leak as claimed in claim 1, wherein a thickness of the resin covering layer is between 1.0 mm and 2.0 mm.

6. A structure for preventing resin leak of an injection molding of a resin covering layer on a covering surface of an insert member using a molding die which includes a first mold and a second mold which forms a cavity in combination with the first mold, the cavity receiving the covering surface of the insert member for forming the resin covering layer, the first mold and the second mold including clamping surfaces which face each other and receive a portion of the insert member therebetween, the structure comprising:
i) a first sealing portion provided on the portion of the insert member facing a location of the clamping surface near the cavity; and
ii) a second sealing portion including:
a) a ridge formed at a location within or near the first sealing portion, the ridge being formed at the portion of the insert member, and
b) a groove formed at a location on the clamping surface which location corresponding to the ridge.

7. The structure for preventing resin leak as claimed in claim 6, wherein the second sealing portion is made when the ridge on the insert member comes into a contact with a side wall of the groove and thereby is deformed.

8. The structure for preventing resin leak as claimed in claim 6, wherein the molding die is for a reaction injection molding.

9. The structure for preventing resin leak as claimed in claim 6, wherein the resin covering layer is made of polyurethane.

10. The structure for preventing resin leak as claimed in claim 6, wherein a thickness of the insert member is between 2.5 mm and 3.5 mm.

11. The structure for preventing resin leak as claimed in claim 6, wherein a thickness of the resin covering layer is between 1.0 mm and 2.0 mm.

12. The structure for preventing resin leak as claimed in claim 6, wherein a force to a contact area between the insert member and the groove of the second mold on the outer side of the cavity is smaller than a force to the other contact area, so that the insert member in the contact area is not affected by compression that occurs during the mold closure.

13. The structure for preventing resin leak as claimed in claim 6, wherein the first sealing portion and the second sealing portion make a pair and a plurality of the pairs are provided in series.

14. The structure for preventing resin leak as claimed in claim 13, wherein the second sealing portion on the cavity side and the second sealing portion on the outer side of the second sealing portion have the same sealing strength.

15. The structure for preventing resin leak as claimed in claim 13, wherein the second sealing portion on the cavity side and the second sealing portion on the outer side of the second sealing portion have different sealing strength.

16. The structure for preventing resin leak as claimed in claim 6, wherein a side wall of the groove is tapered.

17. The structure for prevent resin leak as claimed in claim 6, wherein the groove and the ridge are formed into a step shape in cross section.
